(19) United States
(12) Patent Application Publication
(10) Pub. No.: US 2006/0253509 A1
(43) Pub. Date: Nov. 9, 2006

(54) Method and system for downloading applications into memory-constrained systems

(76) Inventor: Louis P. Slothouber, Leesburg, VA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 11/400,371

(22) Filed: Apr. 10, 2006

Related U.S. Application Data
(60) Provisional application No. 60/669,387, filed on Apr. 8, 2005.

(51) Int. Cl. G06F 15/02; G06F 15/04

(52) U.S. Cl. 708/130

(57) ABSTRACT

A system and method for managing memory by facilitating memory access to memory-constrained electronic input/output devices such as, for example, application system boards, and reference design boards, or digital home communications terminals (DHCTs), such as digital cable boxes, satellite boxes, and Internet Protocol (IP) television set-top boxes, that are used in one or more of cable television systems, satellite television systems, internet protocol television systems, cellular networks, and/or digital subscriber line networks. The system and method allows a user to execute a requested application on an end user device by swapping the least-used memory block in physical memory with a memory block in a virtual memory.

### CROSS-REFERENCE TO RELATED APPLICATIONS

This application claims the benefit of prior U.S. Provisional Application Ser. No. 60/669,387, filed Apr. 8, 2005 and entitled “METHOD AND SYSTEM FOR DOWNLOADING APPLICATIONS INTO MEMORY-CONSTRAINED SYSTEMS,” the disclosure of which is incorporated by reference herein in its entirety.

This application is also related to U.S. patent application Ser. No. 11/350,923, filed Feb. 10, 2006 and entitled “INTERACTING WITH INTERNET APPLICATIONS VIA BROADBAND NETWORK ON ELECTRONIC INPUT/OUTPUT DEVICES,” the disclosure of which is incorporated by reference herein in its entirety.

### FIELD OF THE INVENTION

The present invention relates to electronic memory, and more particularly, to a system for and method of managing memory by facilitating memory access for memory-constrained electronic input/output devices such as digital cable devices, satellite devices, Internet Protocol (IP) television set-top boxes, system boards, and the like.

### BACKGROUND OF THE INVENTION

Computers have evolved into extremely sophisticated devices that can be found in everyday use, such as personal computers, system boards, and application specific computers (“ASIC”). Computers typically perform a wide variety of specialized tasks. Such specialized tasks are usually implemented on different platforms, such as digital television, satellite devices, personal computers, personal digital assistants (“PDA”), wireless telephones, voice over internet protocol (“VoIP”) devices, etc., and within a variety of individual application programs. One of the main components in these modern computer systems is memory. Typically, application programs are loaded into and executed from a primary physical memory, which typically includes random access memory (“RAM”).

Each application program typically requires a corresponding allocation of memory space in the computer system for code and data storage. In addition, computer operating systems usually allocate memory space among multiple application programs.

Because of the ever-increasing computing capabilities of computers, more and more on-board memory is required to run the sophisticated application programs for which these systems are designed. However, specialized system boards often have too little physical memory to hold all the code and data they need in comparison to the memory requirements of one or more application programs needed to be executed. Such limitations on RAM capacity typically place restraints on the number of third-party programs that are designed to facilitate additional user-defined applications.

Therefore, there exists a need for a method and system that will better facilitate the loading and running of application programs in space-constrained memory systems.

### SUMMARY OF THE INVENTION

In view of the deficiencies of the prior art, it is an object of the present invention to provide a system and method that will facilitate access to and the execution of complex program modules in a space-constrained memory environment.

In one embodiment of the present invention, the system and method utilize an in-band data carousel, which may reside elsewhere, for example, at the head-end of a cable television facility. The in-band data carousel may comprise a hardware and software combination that constantly broadcasts compiled code modules. Such compiled code modules may constitute libraries, applications, pieces of libraries, pieces of applications, data, images, and the like. The compiled code modules are constantly available for download, because the in-band data carousel continuously broadcasts all modules. In the event that a program running on a Digital Home Communications Terminal (“DHCT”) requires one of these modules, it tunes to the frequency (i.e., channel) used by the in-band data carousel to broadcast data modules and fetches the module that it requires from the in-band data carousel. The in-band data carousel is thus essentially implemented as a read-only virtual memory.

In another embodiment of the present invention, a number of code modules are compiled and are then stored in a virtual memory such as an in-band data carousel. The in-band data carousel containing the compiled code modules is placed on a back-end server and activated to constantly broadcast the compiled code modules. A program is activated on a local DHCT automatically or by an end-user, triggering the software code to check whether the locally executed program requires any of the compiled code modules. If the program requires such code, the appropriate module is retrieved from the in-band data carousel and swapped for the least recently used block in the memory. Alternatively, or in addition, the embodiment may use other criteria for selecting a module for removal from memory, such as any, or a combination, of least utilized, reference counts, or on the basis of some other requirement.

In yet another embodiment of the present invention, the code modules are compiled and stored in a static in-band data carousel for broadcasting files that may be required more often over and over again. The embodiment may also implement a dynamic carousel that allows other types files to be downloaded only once via an in-band broadcast. Such file types include, by way of non-limiting example, files downloaded from the internet or other sources and requested on an on-demand basis by a set-top box. The requester (e.g., a set-top box) is normally coordinated with the carousel server, and as such, individual files needed for applications by a set-top box may rapidly be downloaded. Such individual applications may include, for example, an EBay™ image.

In still another embodiment of the present invention, a partitioned block of the virtual memory that constitutes an in-band data carousel may contain one or more files required by an application running on a memory-constrained device. Such a partitioned block of virtual memory may be swapped for the least-used partitioned block of the physical memory, which may be moved onto the hard disk of a local machine. For example, the virtual memory may be partitioned into blocks, labeled for illustrative purposes as ‘A,’ ‘B,’ ‘C’ up to ‘Z.’ The local machine may run, for example, a program that resides in a block of the commonly-used memory of the physical memory. Such a program may, for instance, call for an application that resides in block ‘Z’ of the virtual memory. The embodiment relocates the least-utilized block or blocks in the physical memory by moving their contents to the hard disk of the local machine. The requested compiled code module residing in block ‘Z’ of the virtual memory, which is required to run the program residing in the physical memory, is then moved into the formerly least-utilized and now vacant block, and the program is executed.

The foregoing, and other features and advantages of the invention, will be apparent from the following, more particular description of the embodiments of the invention, the accompanying drawings, and the claims.

### BRIEF DESCRIPTION OF THE DRAWINGS

The invention, both as to its structure and operation together with the additional objects and advantages thereof are best understood through the following description of exemplary embodiments of the present invention when read in conjunction with the accompanying drawings.

FIG. 1. is a block diagram illustrating a communication system according an embodiment of the present invention;

FIG. 2. is a flowchart illustrating steps for downloading a software module according to an embodiment of the present invention; and

FIG. 3. is a block diagram illustrating memory management according to an embodiment of the present invention.

### DETAILED DESCRIPTION OF THE INVENTION

The following description is intended to convey a thorough understanding of the invention by providing a number of specific embodiments and details involving various applications of the invention. It is understood, however, that the invention is not limited to these embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

Many computing systems or devices use non-volatile memory (e.g., flash memory or electrically erasable programmable read-only memory, “EEPROM”) to hold program code that may be changed periodically. One example of the usage of non-volatile memory is in the digital cable television provider art. A digital cable provider may, for instance, at a certain time of the day (usually early hours of the morning when equipment usage is at its lowest), download programs and data such as an Electronic Programming Guide (“EPG”), games, polling, or other Interactive Television (“ITV”) applications into a DHCT. Such data may reside in the flash memory of the DHCT until an update is downloaded for replacement. Flash memory is non-volatile, and, as such, any data that are loaded into it will remain there even when the DHCT is turned off.

Generally speaking, digital home communication terminals (“DHCTs”) are divided into two categories: thin clients and thick clients. Thin clients feature basic functionalities, typically just enough to handle basic EPG and video-on-demand (“VOD”) functions, and normally have lower powered central processing units (“CPUs”) and less RAM. Because of these technical limitations, software programs (or applications) for these platforms tend to be based at the television cable plant (i.e., cable head-end) in a client-server arrangement, wherein, typically, a DHCT is used primarily as a simple display device.

One of the limitations of certain thin clients is that there is no mechanism for downloading individual applications to the DHCTs and then executing the downloaded applications. Rather, the applications have to be flashed into the flash memory of the DHCTs. For example, at a certain time of the day, say 3:00 a.m., an application program is flashed into the DHCT, where it stays for a certain period of time (e.g., six months or a year) until it is updated. Therefore, if an application is not installed in the DHCT at the time, it cannot be run. That does not fit well with the model of having multiple small applications that may be deployed incrementally or constantly updated. Such applications must be downloaded as needed. To conserve the scarce memory resources in DHCTs, such applications must also be dynamically removable when not in use.

One possibility for circumventing such a problem may be loading Java Applets as needed and removing those Applets when it is no longer required for executing an application as in the case of certain middleware platforms. One drawback of such a solution is that the Java Applets are typically complete instances of applications that require a significant amount of memory in which to function. In addition, Java applications employ a “garbage collection” memory architecture, a form of automatic memory management that works on the principle of determining what data objects in a program will not be accessed in the future and reclaim any storage used by those objects. Even though such systems are stable, they tend to occupy more RAM memory than carefully coded non-java applications. Furthermore, in some systems, Java libraries must be installed in a flash memory and cannot be downloaded or updated incrementally. As an example, even a minimal configuration provided for Embedded Java requires 256-512K of ROM and 256-512K of RAM to function, which is in addition to the memory space required to run applications. As such, Java Applets are not an optimal solution for loading and running application programs in an arbitrarily small memory partition.

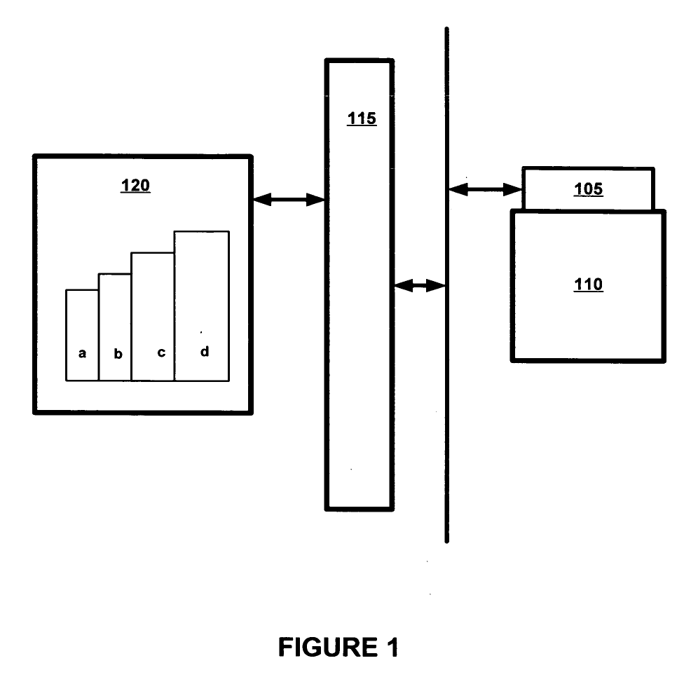

In an embodiment of the present invention, and in reference to FIG. 1, a DHCT equipment 105 may constitute, by way of non-limiting example, any one of a cable box, satellite box, or IPTV (internet protocol television) box, such as Motorola's DCT-2000, located at a user location and coupled to an end-user display 110 such as a television. The DHCT 105 may be configured to receive and run application programs to facilitate end-user demands, such as electronic program guide (EPG), video-on-demand (VOD) programming, among other applications. Because of a limited memory space, other applications such as interactive television may not fit into the DHCT 105.

One embodiment of the present invention utilizes an in-band data carousel 120, which may reside elsewhere, for example, at a head-end 115 of a cable company facility. The in-band data carousel 120, which is typically a hardware-software combination, may constantly broadcast compiled code modules 120(a)-(d). Such compiled code modules 120(a)-(d) may include one or more libraries 120(a), applications 120(b), pieces of libraries 120(c), pieces of applications 120(d), data, images, and the like. The compiled code modules 120(a)-(d) may be constantly available for download, because the in-band data carousel continuously broadcasts some or all of the modules.

When a program requires one of these code modules, it may tune to a frequency (i.e., channel) used by the in-band data carousel 120 to broadcast the code modules, and fetch one or more code modules (or a portion of a code module) that the program needs. From a perspective of the program or the DHCT 105, the in-band data carousel 120 is essentially implemented as a read-only virtual memory.

In yet another embodiment of the invention, and instead of or in addition to broadcasting a set of static modules, the system and method of the present invention may implement a dynamic carousel, which allows other files from the Internet or other sources to be requested dynamically by the set-top boxes, and then downloaded via an in-band channel on an on-demand basis. Unlike the static carousel that broadcasts files over and over again, the dynamic carousel may broadcast files only once (upon requests), and since the set-top box is coordinated with the carousel server, a set-top box can rapidly download individual files needed for individual applications, such as an EBay™ image.

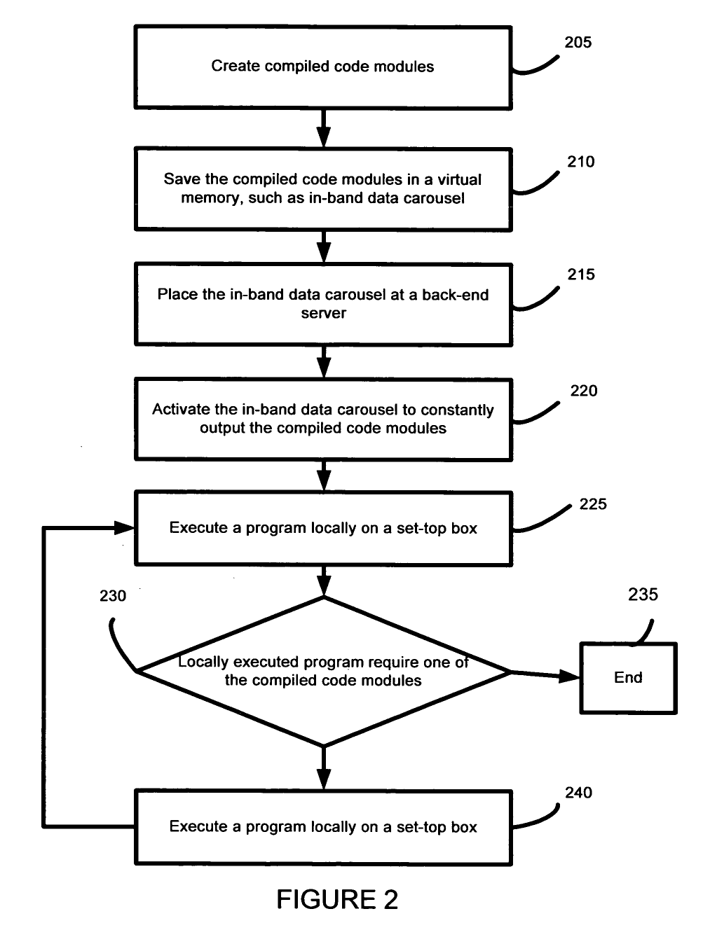

FIG. 2 depicts another embodiment of the present invention. A number of code modules may be compiled in step 205. The compiled code modules are then stored in a virtual memory such as an in-band data carousel in step 210. In step 215, the in-band data carousel containing the compiled code modules may be placed on a back-end server and activated to constantly broadcast the compiled code modules in step 220. In step 225, automatically or initiated by an end-user, a program may be activated on a local DHCT. This program checks, in step 230, whether the locally executed program requires any of the compiled code modules. If the program requires such code modules, the appropriate module is retrieved from the in-band data carousel in step 240 and swapped for a least recently used block in the memory. Otherwise, the process ends in step 235. Other schemes to select a module to remove from memory (e.g., least utilized, or having lowest reference counts, etc.) are also contemplated.

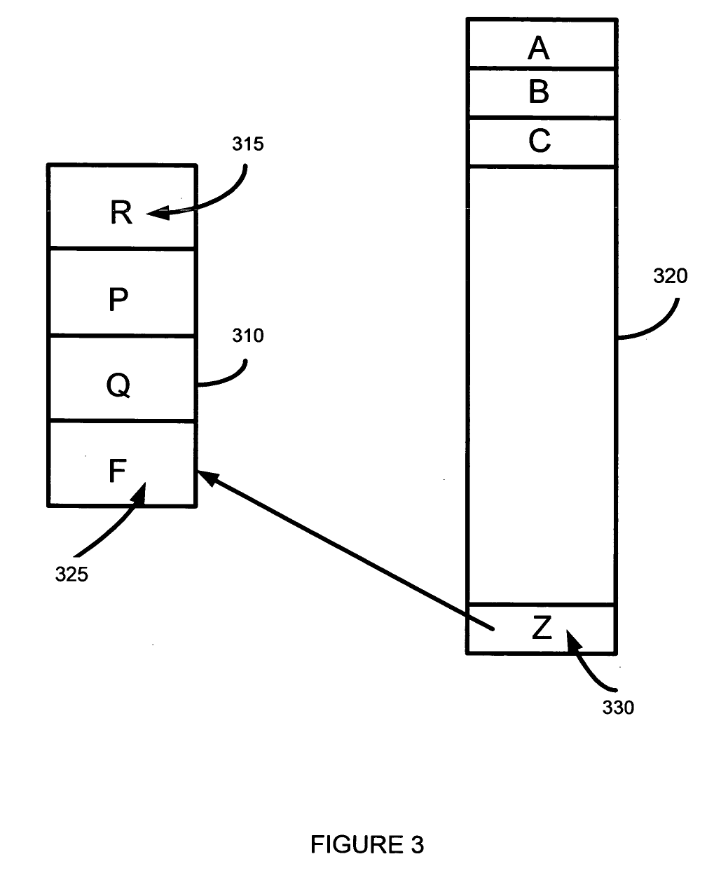

FIG. 3 depicts another embodiment of the present invention. In a local machine (not shown), such as a DHCT, commonly used blocks of a main memory 310 may reside in a physical memory, whereas less commonly used blocks may reside on a hard disk of a local machine. Shown next is a structure 320, which may be a virtual memory that constitutes an in-band data carousel (e.g., 120 of FIG. 1). The virtual memory 320 may be partitioned into blocks, such as ‘A,’ ‘B,’ ‘C’ up to ‘Z.’ The local machine may run, for example, a program that resides in block ‘R’ 315 of the commonly used memory blocks of the physical memory. This program may call for an application that resides in block ‘Z’ 330 of the virtual memory. The least utilized of the blocks in the physical memory, which may be block ‘F’ 320, may then be chosen and moved to the hard disk of the local machine. The compiled code module residing in block ‘Z’ of the virtual memory, which is required to run the program in block ‘R’ 315, may then be moved into the block vacated by ‘F’ 320, upon which move the program may be executed.

From the foregoing it will be appreciated that the system and method of the present invention provides advantages in running applications in a simple, intuitive manner, while making the most efficient use of the available memory resources. Although the above description is specific, it should not be considered as a limitation on the scope of the invention, but only as an example of the preferred embodiment. A number of variations are possible within the teachings of the invention. For example, a different architecture may be used for storing the application required by the system, and the temporary memory may have a different location, or may go by another name. Therefore, the scope of the invention should be determined by the appended claims and their legal equivalents, not by the examples given.

1. A method for facilitating access to and running complex program modules in a space-constrained memory environment, the method comprising:
creating a compiled set of code modules;
creating a virtual file system to store the compiled set of code modules;
broadcasting the compiled set of code modules;
fetching one or more code modules from the compiled set of code modules when an application requires the one or more code modules; and
executing the one or more fetched code modules.

2. The method of claim 1, wherein the virtual file system comprises an in-band data carousel.

3. The method of claim 2, wherein the in-band data carousel is a static data carousel.

4. The method of claim 3, wherein the static data carousel continuously broadcasts application modules and library modules that are occasionally required by one or more applications.

5. The method of claim 2, wherein the in-band data carousel is a dynamic data carousel.

6. The method of claim 5, wherein the dynamic data carousel broadcasts individual files on an on-demand basis.

7. The method of claim 2, wherein the in-band data carousel resides in a back-end gateway.

8. The method of claim 1, wherein the application runs in a device selected from a group consisting of a digital home communications terminal, an application-specific system board, and a specific reference design board.

9. The method of claim 1, wherein the step of fetching does not change the compiled set of code modules.

10. The method of claim 1, further comprising:
moving digital content of a least used memory block to a hard disk.

11. The method of claim 10, wherein the one or more fetched code modules are placed in the least used memory block.

12. A system for facilitating access to and running complex program modules in a space-constrained memory environment, the method comprising:
means for creating a compiled set of code modules;
means for creating a virtual file system to store the compiled set of code modules;
means for broadcasting the compiled set of code modules;
means for fetching one or more code modules from the compiled set of code modules when an application requires the one or more code modules; and
means for executing the one or more code modules.

13. The system of claim 12, wherein the virtual file system comprises an in-band data carousel.

14. The system of claim 13, wherein the in-band data carousel is a static data carousel.

15. The system of claim 14, wherein the static data carousel continuously broadcasts application modules and library modules that are occasionally required by one or more applications.

16. The system of claim 13, wherein the in-band data carousel is a dynamic data carousel.

17. The system of claim 16, wherein the dynamic data carousel broadcasts individual files on an on-demand basis.

18. The system of claim 13, wherein the in-band data carousel resides in a back-end gateway.

19. The system of claim 12, wherein the application runs in a device selected from a group consisting of a digital home communications terminal, an application-specific system board, and a specific reference design board.

20. The system of claim 12, wherein the fetching of the one or more code modules does not change the compiled set of code modules.

21. The system of claim 12, further comprising:
means for moving digital content of a least used memory block to a hard disk.

22. The system of claim 21, wherein the one or more fetched code modules are placed in the least used memory block.
